(19) United States
(12) Patent Application Publication
(10) Pub. No.: US 2004/0213427 A1
(43) Pub. Date: Oct. 28, 2004

(54) Transmitter for headset

(75) Inventor: Sang Man Yoon, Kyungki-do (KR)

Correspondence Address: Ladas & Parry, 26 West 61st Street, New York, NY, 10023, US

(73) Assignee: LINE-TECH CO., LTD.

(21) Appl. No.: 10/650,998

(22) Filed: Aug. 28, 2003

(30) Foreign Application Priority Data
Apr. 24, 2003 (KR) 20-2003-0012775

(51) Int. Cl. H04R 25/00

(52) U.S. Cl. 381/370; 381/182; 381/371; 381/374; 381/375

(57) ABSTRACT

The present invention relates to a headset having a transmitter which is freely rotatable in 3D with respect to a handset housing of a headset. In a headset which includes a built-in handset housing which is electrically connected with a micro speaker and a printed circuit board, a connection line connected with an external terminal from the handset housing, a cushion ring coupled through the handset housing, a headband which is coupled to an upper cover and is putted on a user's head, and a microphone and transmitter connected with the upper cover for thereby transferring a certain sound wave, there is provided a transmitter connection structure of a headset which includes a socket formed in an outer side surface of the upper cover, the microphone formed in a lower portion of the socket in the handset housing, and a ball which is detachably engaged to the socket and is formed in an outer side surface of the transmitter.

### BACKGROUND OF THE INVENTION

1. Field of the Invention

The present invention relates to a transmitter which is freely rotatable with respect to a headset, and in particular to a transmitter for a headset in which a ball rotatable with respect to a socket is formed in a transmitter wherein the socket is formed in an upper cover of a handset housing.

2. Description of the Background Art

As shown in FIG. 1, a conventional headset includes a handset housing 100 which is electrically connected with a micro speaker and a printed circuit board, a connection line 150 which is connected with an external terminal from the handset housing 100, a cushion ring 120 which is engaged to the cover 110 of the handset housing 100, a headband 160 which is engaged with the cover 110 and is putted on a user's head, and a transmitter 130 which is fixed to the cover 110 and includes a microphone 140 for transferring a user voice.

As the micro speaker which is electrically connected with the printed circuit board is provided in the inner side of the handset housing 100, a voice is clearly transferred to a user's ear. The entrance portion of the transmitter 130 is formed in the direction of a user's mouth, so that a user's voice is effectively transferred into the inner space of the transmitter 130 and is converted into an electrical signal by the microphone 140 and is transferred to the headset handset. The user's voice transferred to the headset handset is transferred to an opponent through the connection line 150 for thereby implementing a voice communication.

In addition, a T-bar 170 is provided in the other side of the headband 160 which is engaged to an upper side of the upper cover 110 of the handset housing 100 and is putted on the user's head, for thereby preventing the headband 160 from being escaped from the user's head.

However, the thusly constructed transmitter includes a microphone and an electric wire for transferring an electrical signal, so that there is a limit in a rotational angle of the transmitter. As the transmitter is connected in such a manner that the transmitter is rotatable only based on the plane in 2D(two dimension), in the case that the physical body shapes of the users are different, it is impossible to clearly transfer a voice signal to an opponent through the transmitter.

### SUMMARY OF THE INVENTION

Accordingly, it is an object of the present invention to provide a transmitter for a headset which is freely rotatable in 3D(three dimension) in such a manner that a microphone is installed in a handset housing.

It is another object of the present invention to provide a transmitter for a headset which is capable of implementing an easier carry and storage of a headset in such a manner that a transmitter is detachably engaged to a handset housing and is capable of clearly transferring a user's voice to an opponent by variably adjusting the length of the transmitter based on the physical body shapes of users.

To achieve the objects, in a headset which includes a built-in handset housing which is electrically connected with a micro speaker and a printed circuit board, a connection line connected with an external terminal from the handset housing, a cushion ring coupled through the handset housing, a headband which is coupled to an upper cover and is putted on a user's head, and a microphone and transmitter connected with the upper cover for thereby transferring a certain sound wave, there is provided a transmitter for a headset, comprising a socket formed in an outer side surface of the upper cover, the microphone formed in a lower portion of the socket in the handset housing, and a ball which is detachably engaged to the socket and is formed in an outer side surface of the transmitter.

In the present invention, the socket and ball are formed of an elastic material so that the ball is detachable with respect to the socket.

The transmitter is formed of an upper pipe and a lower pipe which is coupled into the interior of the upper pipe for thereby variably adjusting the length of the same. A ball is formed in one side end portion of the upper pipe, and a guide rail having protrusion at a regular interval is formed along an inner side surface of the upper pipe. The grooves corresponding to the protrusions are formed in an outer side surface of the lower pipe. An end portion of the lower pipe is bent in a direction of a user's mouth for thereby being engaged to the upper pipe.

### BRIEF DESCRIPTION OF THE DRAWINGS

The present invention will become better understood with reference to the accompanying drawings which are given only by way of illustration and thus are not limitative of the present invention, wherein;

FIG. 1 is a perspective view illustrating a conventional headset;

FIG. 2 is a perspective view illustrating a headset according to an embodiment of the present invention;

FIG. 3 is a disassembled perspective view illustrating a headset according to an embodiment of the present invention;

FIG. 4 is a cross sectional view illustrating a coupling state of a ball and a socket according to the present invention;

FIG. 5 is a perspective view illustrating a transmitter according to an embodiment of the present invention;

FIG. 6 is a cross sectional view illustrating a transmitter of FIG. 5;

FIG. 7 is a partial enlarged cross sectional view illustrating a transmitter according to another embodiment of the present invention; and

FIG. 8 is a perspective view illustrating a state of use of a headset according to an embodiment of the present invention.

### DETAILED DESCRIPTION OF THE PREFERRED EMBODIMENTS

The preferred embodiments of the present invention will be described with reference to the accompanying drawings.

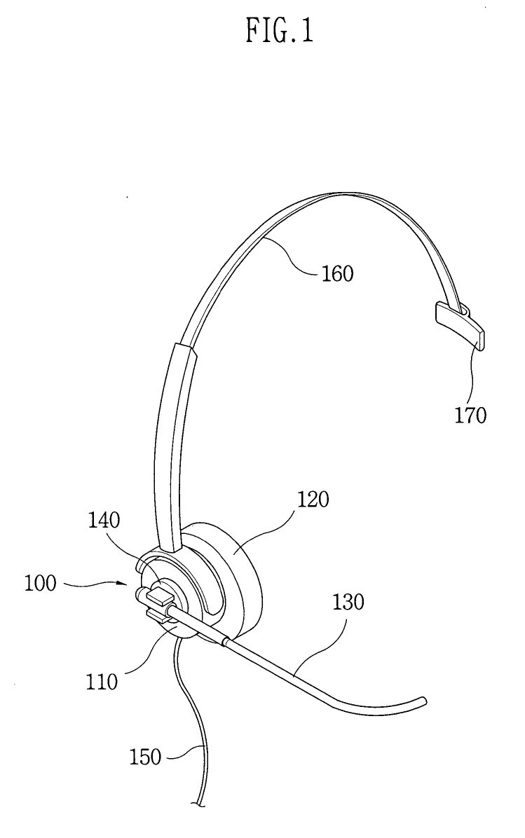

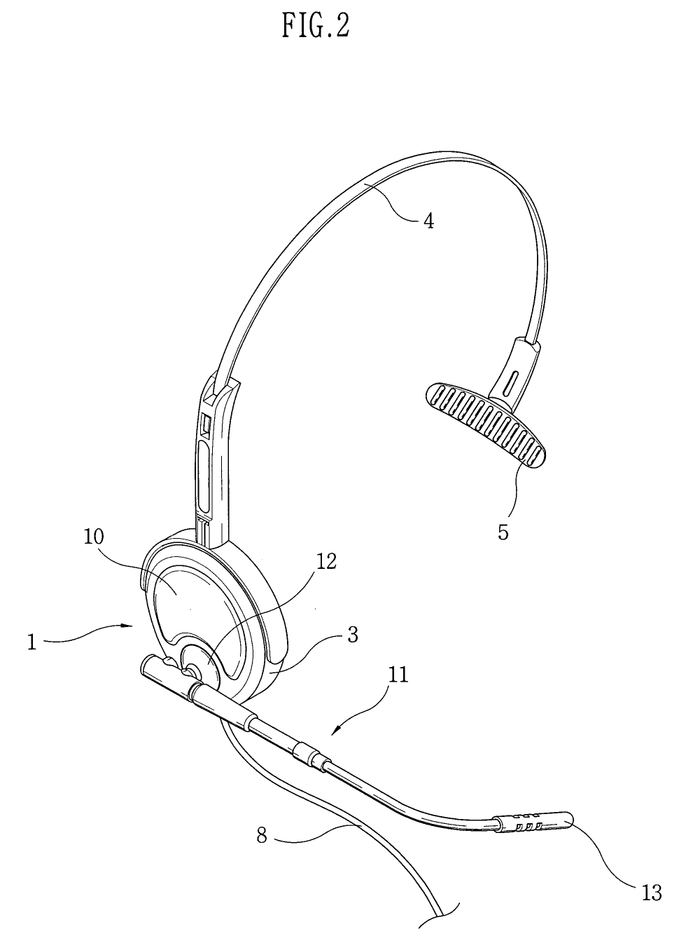

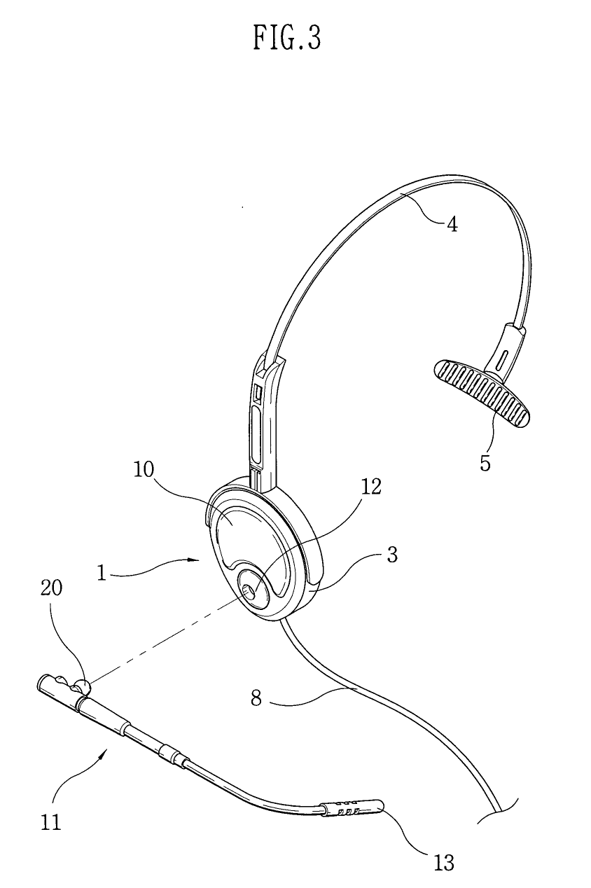

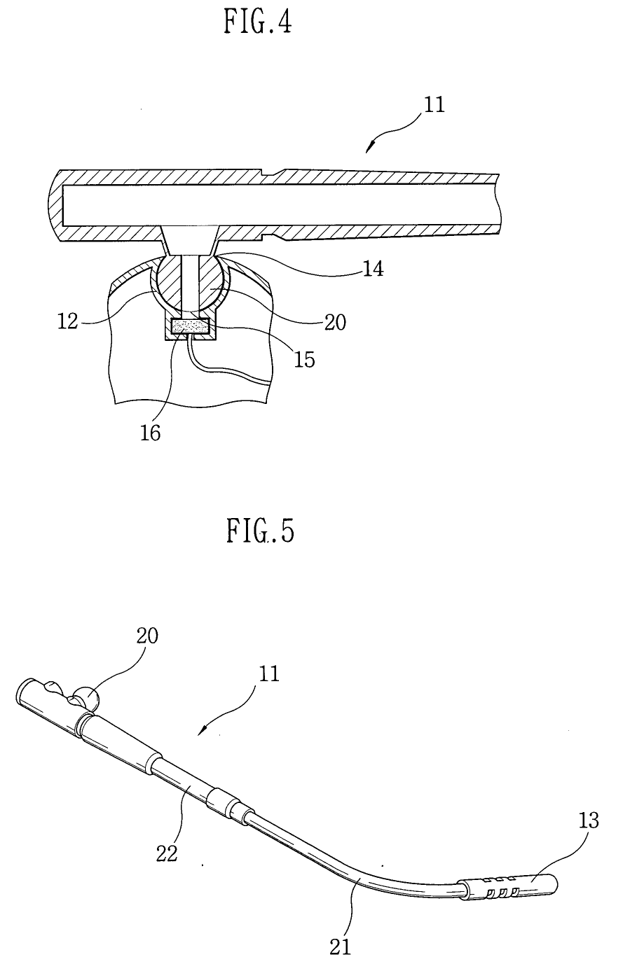

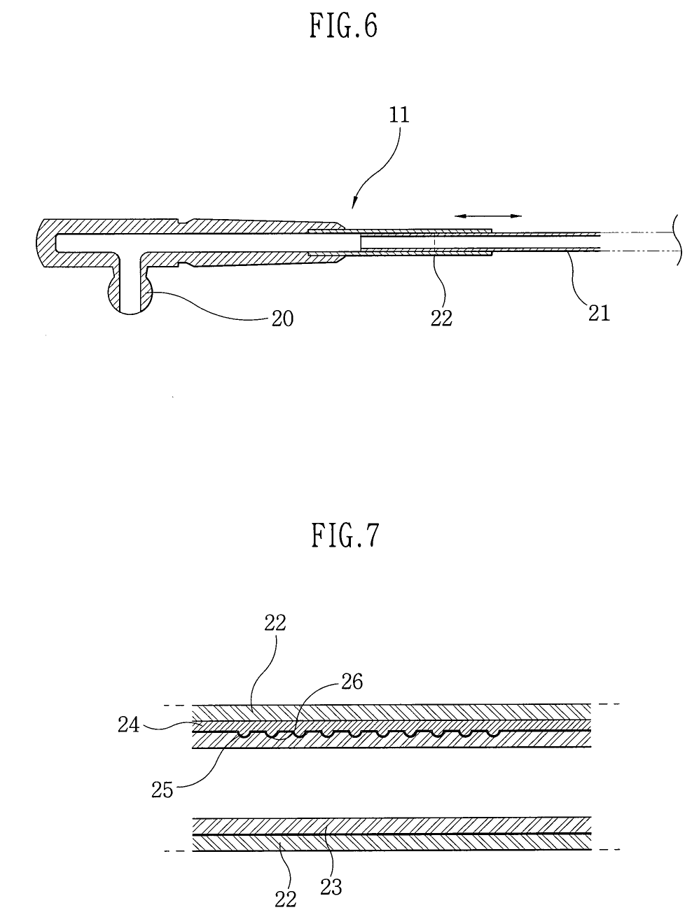

As shown in FIGS. 2 through 6, the present invention is directed to a headset which includes a handset housing 1 which is electrically connected with a micro speaker and a printed circuit board, a connection line 8 which is connected with an external terminal from the handset housing 1, a cushion ring 3 which is coupled to an upper cover of the handset housing 1, a headband 4 which is coupled to the upper cover 10 and is putted on a user's head, a transmitter 11 which is connected with the upper cover 10 for thereby transferring an audio wave, and a microphone. Since the above constructions are actually adapted to the constructions of FIG. 1, the detailed descriptions on the construction and operation of the same will be omitted.

Therefore, in the transmitter for the headset according to an embodiment of the present invention, a socket 12 is formed in one side of the upper cover 10. The microphone 16 is formed below the socket 12 in the handset housing 1. A ball 20 detachably engaged to the socket 12 is formed in one side end portion of the transmitter 11.

The socket 12 adapted to connecting the transmitter 211 is installed in an outer side surface of the upper cover 10 in such a manner that the socket 12 is formed in a circular shape for rotatably supporting the ball 20 of the transmitter 11. Here, the socket 12 is formed of an upper opening 14 into which the ball 20 of the transmitter 11 is inserted, and a lower opening 15 for transferring an audio signal from the transmitter 11.

In addition, a microphone 16 is installed below the lower opening 15 of the socket 12. The socket 12 is formed of an elastic material so that the ball 20 of the transmitter 11 is detachably coupled through the upper opening 14. Preferably, the socket 12 is formed of a plastic material.

The conventional microphone 16 is installed near the entrance of the transmitter 11, so that the electrical wire for transferring an electrical signal is installed in the interior of the transmitter 11. However, in the present invention, in order to implement a freely rotatable transmitter 11, the electrical wire is installed in the handset housing 1 of the headset, and the audio signal from the transmitter 11 is transferred through the lower opening 15 of the socket.

The transmitter 11 is formed of an upper pipe 22 formed in a pipe shape for transferring an audio signal, and a lower pipe 21 which is engaged into an inner side of the upper pipe 22. The transmitter 11 has a ball 20 engaged to the socket 12 in one side of the same. A noise filter 13 is provided in an end portion of the transmitter 11 which is formed in the direction of the user's mouth for thereby decreasing the noise.

The ball 20 installed in the transmitter 11 is formed of a plastic material having a certain elastic force for thereby being detachably engaged through the upper opening 14 of the socket 12.

The operation of the transmitter for a headset according to the present invention will be described with reference to the accompanying drawings.

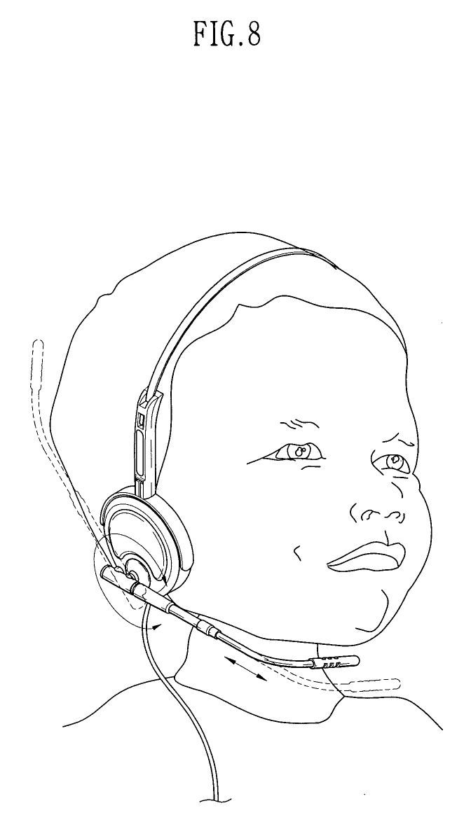

As shown in FIG. 8, a voice (audio signal) from a user's mouth is transferred to the microphone 16 through a pipe shaped transmitter 11, the ball 20 formed in one end of the transmitter 11, and the socket 12 of the upper cover 10 of the handset housing 1.

The microphone 16 is installed in the handset housing 1, and the transmitter 11 and the handset housing 1 are rotatably connected each other using the ball 20 and the socket 12. Therefore, the transmitter 11 is freely rotatable with respect to the handset housing 1. Namely, in the present invention, the transmitter 11 is rotatable in 3D, not in 2D of 360° rotation. Therefore, it is very convenient to use the same.

As shown in FIGS. 7 and 8, in the transmitter of the headset according to another embodiment of the present invention, the transmitter 11 is formed of an upper pipe 22, and a lower pipe 23 which is engaged into the upper pipe 22 for thereby adjusting the length of the same. A ball (not shown) is installed in one side end portion of the upper pipe 22. A guide rail 24 having protrusions 25 along an inner surface of the upper pipe 22 at a regular interval is provided. A groove 26 corresponding to the protrusion 25 is formed in an outer side surface of the lower pipe 23. An end portion of the lower pipe 23 is bent in the direction of the user's mouth, and is engaged with the upper pipe 22.

The upper pipe 22 has a ball 20 engaged to the socket 12 of the upper cover 10 of the handset housing 1 and is formed in a pipe shape for transferring an audio signal. A guide rail 24 is installed in an inner side surface of the upper pipe 22 for guiding the movement of the lower pipe 23. The protrusions 25 are provided in the guide rail 24 at a regular interval for implementing an accurate movement of the lower pipe 23.

The lower pipe 23 is engaged into the inner side of the upper pipe 22 and is formed in a pipe shape for transferring an audio signal. A noise filter 13 is installed in an end portion of the lower pipe 23 near the user's mouth portion. A guideline corresponding to the guide rail 24 is formed in an outer side surface of the lower pipe 23 and is moved along the guide rail 24. A groove 26 corresponding to the protrusion 25 is formed in the guideline for thereby guiding an accurate movement.

In the present invention, the length of the transmitter 11 is adjustable by moving the lower pipe 23 with respect to the upper pipe 22. The upper and lower pipes 22 and 23 are moved along the guide rail 24 and the guideline, so that it is possible to implement an accurate position movement at a regular interval based on the protrusion 25 and the groove 26. At this time, the upper and lower pipes 22 and 23 may be fixed by the protrusion 25 and the groove 26 during the movement of the position. A certain sound is generated when the position is moved.

As shown in FIG. 8, in the headset according to the present invention, the transmitter 11 is freely rotatable in 3D with respect to the handset housing 1, and the length of the transmitter 11 is variable.

The transmitter for a headset according to the present invention has the following advantages.

In the headset of the present invention, the transmitter is freely rotatable in 3D compared to the conventional transmitter which is rotatable in 2D. In addition, since the ball is detachable from the socket, it is possible exchange only the transmitter with respect to the handset housing.

In addition, since the transmitter is detachably engaged to the handset housing, an easier carry and storage of the headset are implemented. It is possible variably adjust the length of the transmitter based on the physical body shapes of users, so that a user's voice is clearly transferred to an opponent for thereby enhancing a reliability of the product.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. In a headset which includes a built-in handset housing which is electrically connected with a micro speaker and a printed circuit board, a connection line connected with an external terminal from the handset housing, a cushion ring coupled through the handset housing, a headband which is coupled to an upper cover and is putted on a user's head, and a transmitter connected with the upper cover for thereby transferring a certain sound wave, the transmitter for the headset comprising:
a socket formed in an outer side surface of the upper cover;
said microphone formed in a lower portion of the socket in the handset housing; and
a ball which is detachably engaged to the socket and is formed in an outer side surface of the transmitter.

2. The transmitter of claim 1, wherein said ball is rotatably engaged to the socket so that the transmitter is rotatable in 3D with respect to the handset housing.

3. The transmitter of claim 1, wherein said transmitter capable of variably adjusting the length of the transmitter includes:
an upper pipe in which the ball is formed; and
a lower pipe which is extendably coupled into the interior of the upper pipe.

4. The transmitter of claim 3, wherein a guide rail having grooves formed at a regular interval is coupled along an inner side surface of the upper pipe, and a protrusion corresponding to each groove is formed in an outer side surface of the lower pipe for thereby implementing a coupling with the upper pipe.

5. The transmitter of claim 1, wherein said socket and ball are formed of an elastic material so that the ball is detachable with respect to the socket.

6. The transmitter of claim 1, wherein a noise filter is formed in an end portion of the transmitter for decreasing a noise except for a user's voice.

7. The transmitter of claim 2, wherein said transmitter capable of variably adjusting the length of the transmitter includes:
an upper pipe in which the ball is formed; and
a lower pipe which is extendably coupled into the interior of the upper pipe.
